(19) United States
(12) Patent Application Publication
(10) Pub. No.: US 2010/0097271 A1
(43) Pub. Date: Apr. 22, 2010

(54) Radome and microstrip patch antenna having the same

(75) Inventor: The-Nan Chang, Taipei (TW)

Correspondence Address: BACON & THOMAS, PLLC, 625 SLATERS LANE, FOURTH FLOOR, ALEXANDRIA, VA, 22314-1176, US

(73) Assignees: Tatung University, Taipei (TW); Tatung Company, Taipei (TW)

(21) Appl. No.: 12/382,885

(22) Filed: Mar. 26, 2009

(30) Foreign Application Priority Data
Oct. 16, 2008 (TW) 097139726

(51) Int. Cl. H01Q 1/38

(52) U.S. Cl. 343/700 MS

(57) ABSTRACT

A radome and a microstrip patch antenna having the same are disclosed. The gain value of the microstrip patch antenna having the disclosed radome can be increased while the size thereof remains in a limited size. The disclosed radome comprises: a radome body, having an upper surface and a lower surface; a first gain-enhancing pattern, locating on the upper surface and including a plurality of first ring gain-enhancing units; and a second gain-enhancing pattern, locating on the lower surface and including a plurality of second ring gain-enhancing units. The first ring gain-enhancing unit includes a first conductive ring and a second conductive ring, and the second ring gain-enhancing unit includes a third conductive ring and a fourth conductive ring. Besides, the opening direction of the third conductive ring is perpendicular to the opening direction of the first conductive ring.

### BACKGROUND OF THE INVENTION

1. Field of the Invention

A radome and a microstrip patch antenna having the same are disclosed. More particularly, the gain value of the disclosed microstrip patch antenna having the disclosed radome can be increased while the size thereof remains in a limited size.

2. Description of Related Art

In recent years, in order to improve the gain for emitting a high frequency signal (both circularly polarized or linearly polarized) of a microstrip patch antenna, and eliminate the need to apply a much-complicated method (i.e. the power combining techniques), the industry has proposed a method called resonance gain method. This method includes the step of stacking plural dielectric layers on each other, and the following step of placing the resulting multi-layered dielectric layer structure on top of a microstrip patch antenna, wherein an air-layer may be sandwiched by the multi-layered dielectric layer structure and the microstrip patch antenna.

However, the microstrip patch antenna having the multi-layered dielectric layer structure thereon has a certain thickness, which limits the application field of this kind of microstrip patch antenna. Moreover, as the resonance gain method includes the step of continuously stacking plural dielectric layers each having certain thickness, the manufacturing cost of this method is much higher. Therefore, the radome made by this method has not yet been evaluated in the application of emitting/receiving circularly polarized high frequency signals.

As a result, it is desired to have a radome which can improve the gain value of a microstrip patch antenna having the radome, without increasing the thickness of the microstrip patch antenna, and can improve the operation performance of the microstrip patch antenna in emitting/receiving circularly polarized high frequency signals.

### SUMMARY OF THE INVENTION

The main object of the present invention is to provide radome, wherein the gain value of the microstrip patch antenna having the radome can be increased, and the antenna can have better performance while emitting or receiving a circularly polarized signal.

The secondary object of the present invention is to provide microstrip patch antenna, wherein the gain value of the antenna can be increased while the size thereof remains in a limited size.

To achieve the above object, the radome of the present invention comprises: a radome body, having an upper surface and a lower surface; a first gain-enhancing pattern, locating on the upper surface and including a plurality of first ring gain-enhancing units; and a second gain-enhancing pattern, locating on the lower surface and including a plurality of second ring gain-enhancing units.

To achieve the above object, the microstrip patch antenna of the present invention comprises: a substrate; an antenna body, locating on the surface of the substrate; and a radome, locating above the antenna body, and the antenna body being located between the substrate and the radome; wherein the radome includes a radome body having an upper surface and a lower surface, a first gain-enhancing pattern and a second gain-enhancing pattern. The first gain-enhancing pattern locates on the upper surface and includes a plurality of first ring gain-enhancing units, and the second gain-enhancing pattern locates on the lower surface and includes a plurality of second ring gain-enhancing units.

Therefore, by having the radome body that comprises a first gain-enhancing pattern and a second gain-enhancing pattern on the upper surface and the lower surface thereof respectively, wherein the first gain-enhancing pattern includes a plurality of first ring gain-enhancing units and the second gain-enhancing pattern includes a plurality of second ring gain-enhancing units, the gain value of a microstrip patch antenna having the radome of the present invention can be increased significantly. Moreover, the thickness of the radome of the present invention almost equals to the thickness of the radome body thereof (i.e. 0.8 mm), which is significantly thinner than the conventional radome. As a result, the gain value of the microstrip patch antenna having the radome of the present invention (i.e. the microstrip patch antenna of the present invention) can be increased significantly, and the circular property of the microstrip patch antenna can also be maintained at a certain level, while the size of the antenna remains in a limited size.

Other objects, advantages, and novel features of the invention will become more apparent from the following detailed description when taken in conjunction with the accompanying drawings.

### BRIEF DESCRIPTION OF THE DRAWINGS

FIG. 1A is a perspective view of the radome according to one embodiment of the present invention.

FIG. 1B is a top view showing the upper surface of the radome body of the radome according to one embodiment of the present invention.

FIG. 1C is a top view showing the lower surface of the radome body of the radome according to one embodiment of the present invention.

FIG. 2A is a perspective view of the radome according to the other embodiment of the present invention.

FIG. 2B is a top view showing the upper surface of the radome body of the radome according to the other embodiment of the present invention.

FIG. 2C is a top view showing the lower surface of the radome body of the radome according to the other embodiment of the present invention.

FIG. 3A is a perspective view of the microstrip patch antenna according to one another embodiment of the present invention.

FIG. 3B is a top view showing the antenna body of the microstrip patch antenna according to one another embodiment of the present invention.

FIG. 3C is a top view showing the upper surface of the radome of the microstrip patch antenna according to one another embodiment of the present invention.

FIG. 3D is a top view showing the lower surface of the radome of the microstrip patch antenna according to one another embodiment of the present invention.

FIG. 3E shows the first ring gain unit of the first gain-enhancing pattern of the radome of the microstrip patch antenna according to one another embodiment of the present invention.

FIG. 4A is a schematic diagram showing the variation between the axial ratio and the frequency of a microstrip patch antenna capable of emitting or receiving a circularly polarized high frequency signal, obtained from the simulation performed by an electromagnetic simulation software.

FIG. 4B is a schematic diagram showing the variation between the return loss and the frequency of a microstrip patch antenna capable of emitting or receiving a circularly polarized high frequency signal, obtained from the simulation performed by an electromagnetic simulation software.

FIG. 5A is a schematic diagram showing the variation between the return loss and the frequency of a microstrip patch antenna according to one another embodiment of the present invention, obtained from the simulation performed by an electromagnetic simulation software and from the measurement on the microstrip patch antenna.

FIG. 5B is a schematic diagram showing the variation between the axial ratio and the frequency of a microstrip patch antenna according to one another embodiment of the present invention, obtained from the simulation performed by an electromagnetic simulation software and from the measurement on the microstrip patch antenna.

FIG. 5C is a schematic diagram showing the variation between the gain and the frequency of a microstrip patch antenna according to one another embodiment of the present invention, obtained from the simulation performed by an electromagnetic simulation software and from the measurement on the microstrip patch antenna.

FIG. 6A is a perspective view of the microstrip patch antenna according to still another embodiment of the present invention.

FIG. 6B is a top view showing the upper surface of the radome of the microstrip patch antenna according to still another embodiment of the present invention.

FIG. 6C is a top view showing the lower surface of the radome of the microstrip patch antenna according to still another embodiment of the present invention.

FIG. 7A is a perspective view of the microstrip patch antenna according to still another embodiment of the present invention.

FIG. 7B is a top view showing the upper surface of the radome of the microstrip patch antenna according to still another embodiment of the present invention.

FIG. 7C is a top view showing the lower surface of the radome of the microstrip patch antenna according to still another embodiment of the present invention.

FIG. 8A is a schematic diagram showing the variations between the return loss and the frequency of the microstrip patch antennas according to one another embodiment, still another embodiment, and still another embodiment of the present invention, respectively, obtained from the simulation performed by an electromagnetic simulation software.

FIG. 8B is a schematic diagram showing the variations between the gain and the frequency of the microstrip patch antennas according to one another embodiment, still another embodiment, and still another embodiment of the present invention, respectively, obtained from the simulation performed by an electromagnetic simulation software.

FIG. 8C is a schematic diagram showing the variations between the axial ratio and the frequency of the microstrip patch antennas according to one another embodiment, still another embodiment, and still another embodiment of the present invention, respectively, obtained from the simulation performed by an electromagnetic simulation software.

### DETAILED DESCRIPTION OF THE PREFERRED EMBODIMENT

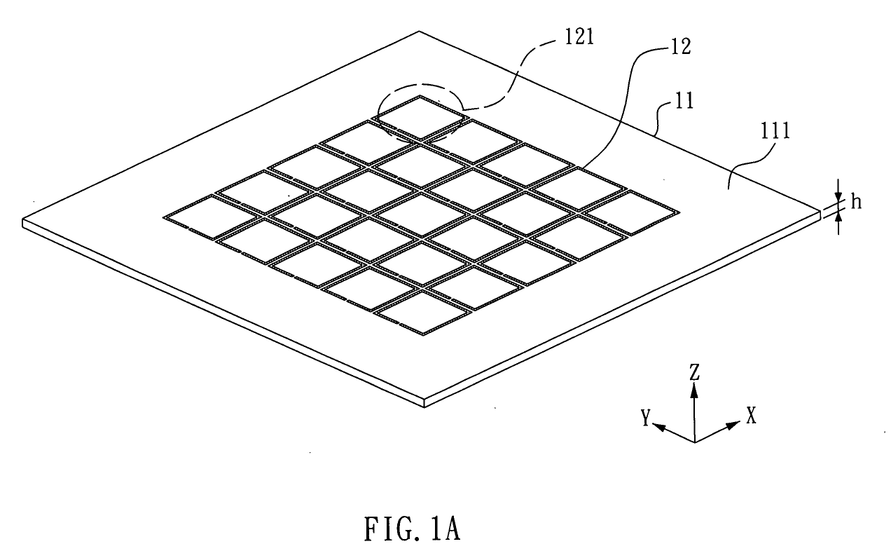

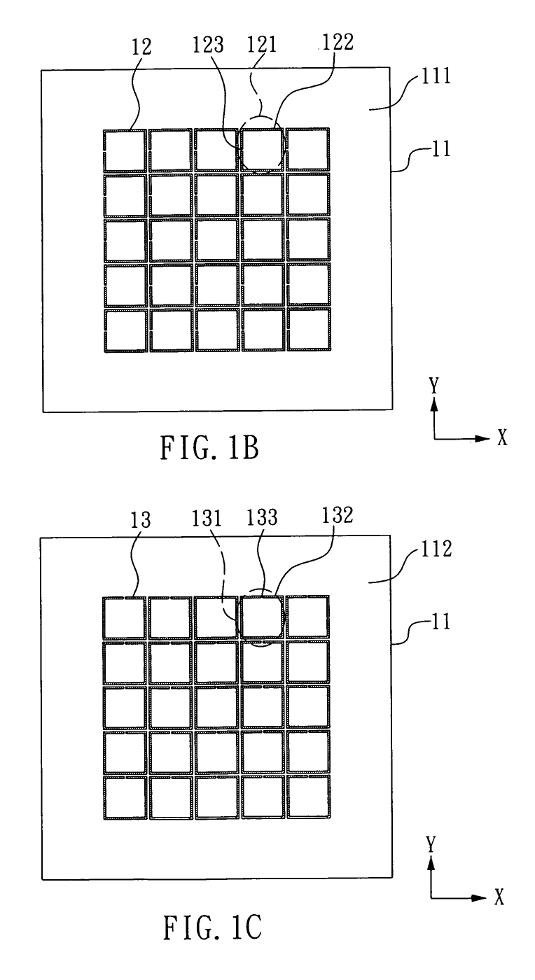

With reference to FIG. 1A, FIG. 1B and FIG. 1C, the radome according to one embodiment of the present invention comprises: a radome body 11, a first gain-enhancing pattern 12, and a second gain-enhancing pattern 13, wherein the radome body 11 has an upper surface 111 and a lower surface 112. The first gain-enhancing pattern 12 is located on the upper surface 111 and includes a plurality of first ring gain-enhancing units 121. The second gain-enhancing pattern 13 is located on the lower surface 112 and includes a plurality of second ring gain-enhancing units 131.

In the present embodiment, the radome body 11 is an FR-4 substrate having the thickness h=0.8 mm. Besides, the first gain-enhancing pattern 12 includes 25 first ring gain-enhancing units 121, wherein these first ring gain-enhancing units 121 are arranged as a 5 by 5 matrix on the upper surface 111 of the radome body 11. The second gain-enhancing pattern 13 includes 25 second ring gain-enhancing units 131, wherein these second ring gain-enhancing units 131 are arranged as a 5 by 5 matrix on the lower surface 112 of the radome body 11. Moreover, as shown in FIG. 1A, the first gain-enhancing pattern 12 and the second gain-enhancing pattern 13 are formed on the upper surface 111 and the lower surface 112 of the radome body 11 correspondingly and respectively.

As shown in FIG. 1B and FIG. 1C, the first ring gain-enhancing units 121 is a first single ring 122, while the second ring gain-enhancing units 131 is a second single ring 132. Besides, the first single ring 122 and the second single ring 132 have an opening 123, 133, respectively. Moreover, the opening direction of the first single ring 122 (i.e. the X-direction of FIG. 1B) is perpendicular to the opening direction of the second single ring 132 (i.e. the Y-direction of FIG. 1C).

It should be noticed that, even though the first single ring 122 and the second single ring 132 are rectangular ring in the present embodiment, the first single ring 122 and the second single ring 132 can be any kind of rings, such as circular ring or elliptical ring, depending on the requirement in different applications.

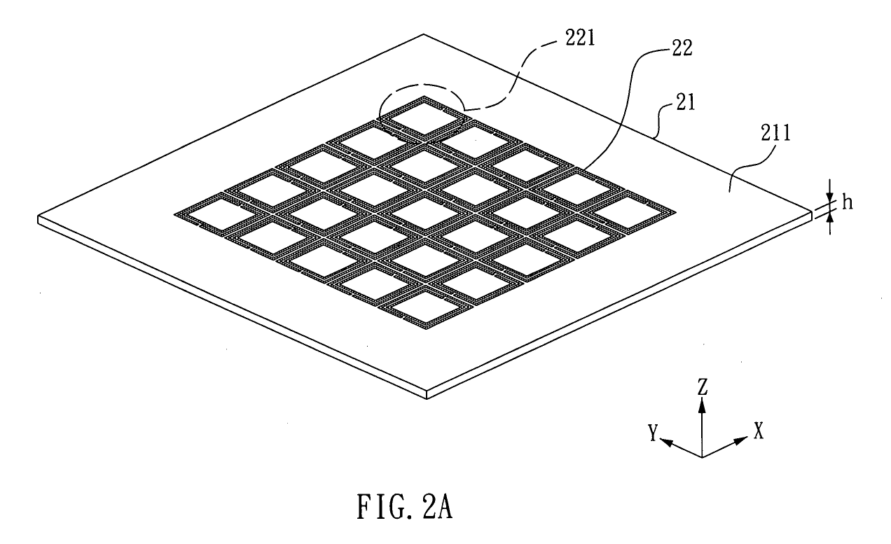

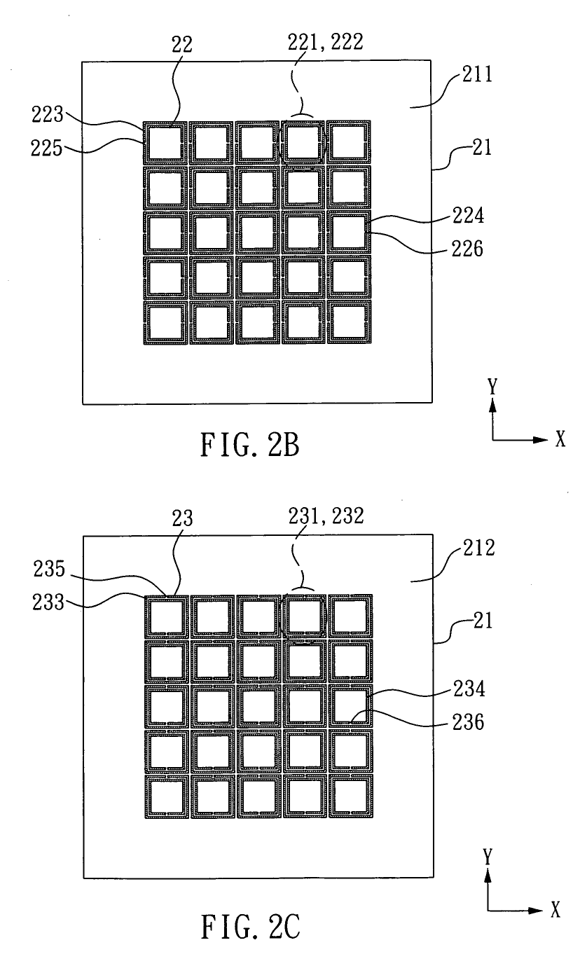

With reference to FIG. 2A, FIG. 2B and FIG. 2C, the radome according to the other embodiment of the present invention comprises: a radome body 21, a first gain-enhancing pattern 22, and a second gain-enhancing pattern 23, wherein the radome body 21 has an upper surface 211 and a lower surface 212. The first gain-enhancing pattern 22 is located on the upper surface 211 and includes a plurality of first ring gain-enhancing units 221. The second gain-enhancing pattern 23 is located on the lower surface 212 and includes a plurality of second ring gain-enhancing units 231.

In the present embodiment, the radome body 21 is an FR-4 substrate having the thickness h=0.8 mm. Besides, the first gain-enhancing pattern 22 includes 25 first ring gain-enhancing units 221, wherein these first ring gain-enhancing units 221 are arranged as a 5 by 5 matrix on the upper surface 211 of the radome body 21. The second gain-enhancing pattern 23 includes 25 second ring gain-enhancing units 231, wherein these second ring gain-enhancing units 231 are arranged as a 5 by 5 matrix on the lower surface 212 of the radome body 21. Moreover, as shown in FIG. 2A, the first gain-enhancing pattern 22 and the second gain-enhancing pattern 23 are formed on the upper surface 211 and the lower surface 212 of the radome body 21 correspondingly and respectively.

As shown in FIG. 2B and FIG. 2C, the first ring gain-enhancing units 221 is a first split ring resonator 222, while the second ring gain-enhancing units 231 is a second split ring resonator 232. The first split ring resonator 222 includes a first conductive ring 223 and a second conductive ring 224, wherein the second conductive ring 224 is enclosed by the first conductive ring 223. The second split ring resonator 232 includes a third conductive ring 233 and a fourth conductive ring 234, wherein the fourth conductive ring 234 is enclosed by the third conductive ring 233.

Besides, as shown in FIG. 2B and FIG. 2C, the first conductive ring 223 and the second conductive ring 224 have an opening 225, 226, respectively. The opening direction of the first conductive ring 223 is opposite to the opening direction of the second conductive ring 224. The third conductive ring 233 and the fourth conductive ring 234 have an opening 235, 236, respectively. The opening direction of the third conductive ring 233 is opposite to the opening direction of the fourth conductive ring 234. Moreover, the opening direction of the first conductive ring 223 (i.e. the X-direction of FIG. 2B) is perpendicular to the opening direction of the third conductive ring 233 (i.e. the Y-direction of FIG. 2C).

It should be noticed that, even though the first conductive ring 223, the second conductive ring 224, the third conductive ring 233 and the fourth conductive ring 234 are rectangular ring in the present embodiment, the first conductive ring 223, the second conductive ring 224, the third conductive ring 233 and the fourth conductive ring 234 can be any kind of rings, such as circular ring or elliptical ring, depending on the requirement in different applications.

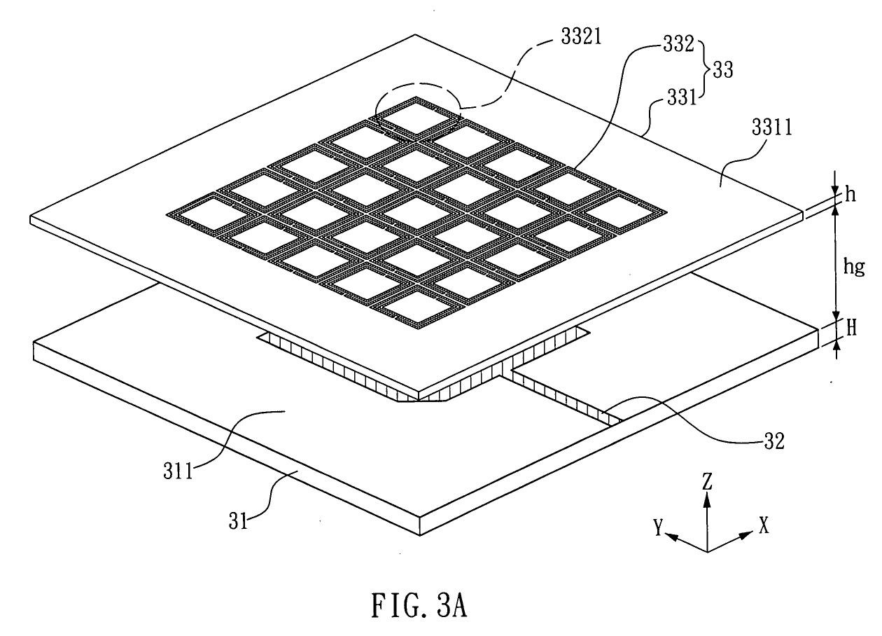

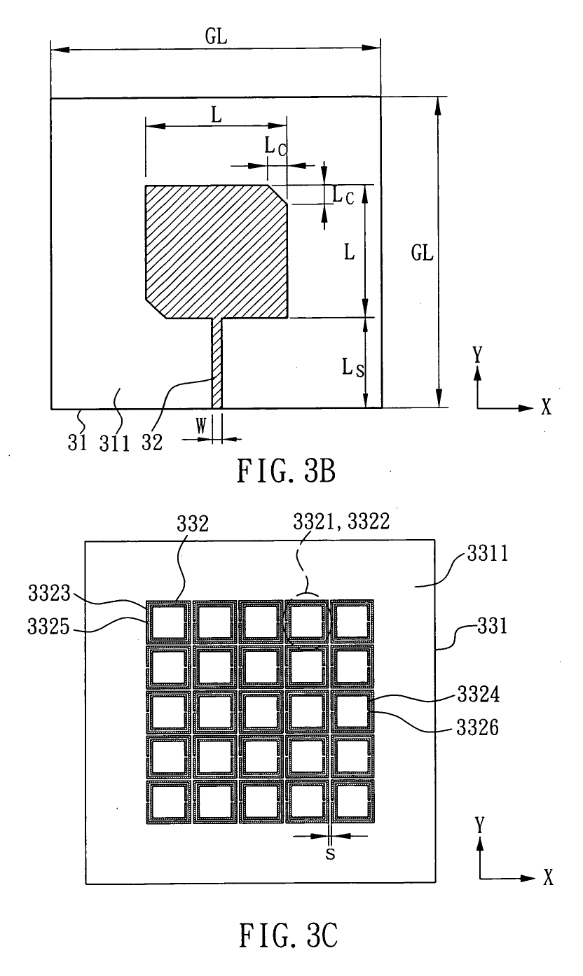

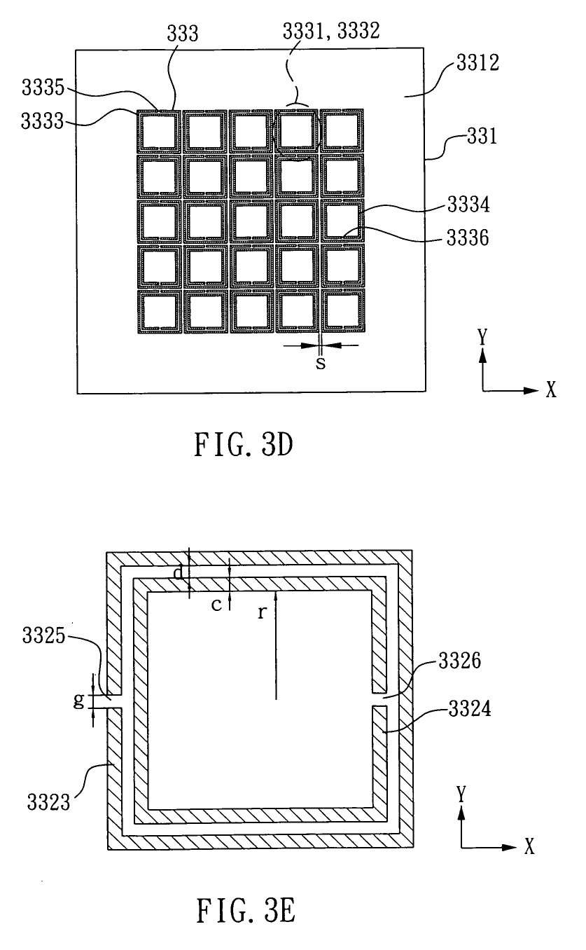

With reference to FIG. 3A, the microstrip patch antenna according to one another embodiment of the present invention comprises: a substrate 31, an antenna body 32 and a radome 33, wherein the antenna body 32 is located on the surface 311 of the substrate 31, and the radome 33 is located above the antenna body 32. The antenna body 32 is located between the substrate 31 and the radome 33. Besides, in the present embodiment, the substrate 31 is an FR-4 substrate having the thickness H=1.6 mm. The radome 33 is also an FR-4 substrate having the thickness h=0.8 mm. Moreover, an air layer is sandwiched between the antenna body 32 and the radome 33, having the thickness hg=13 mm.

As shown in FIG. 3B, the antenna body 32 is located on the surface 311 of the substrate 31. Since the antenna body 32 is truncated, the microstrip patch antenna according to one another embodiment of the present invention can emit or receive a high frequency signal having a circular polarization. The values of the labels in FIG. 3B for showing the size of the antenna body 32 and the substrate 31 are listed in the Table 1 below:

TABLE 1

| Label | Value (mm) | Label | Value (mm) | Label | Value (mm) |
|---|---|---|---|---|---|
| GL | 69 | L | 29 | Ls | 20 |
| W | 2 | Lc | 4 | | |

With reference to FIG. 3A, FIG. 3C and FIG. 3D, the radome 33 includes a radome body 331, a first gain-enhancing pattern 332, and a second gain-enhancing pattern 333, wherein the radome body 331 has an upper surface 3311 and a lower surface 3312. The first gain-enhancing pattern 332 is located on the upper surface 3311 and includes a plurality of first ring gain-enhancing units 3321. The second gain-enhancing pattern 333 is located on the lower surface 3312 and includes a plurality of second ring gain-enhancing units 3331.

Besides, in the present embodiment, the first gain-enhancing pattern 332 includes 25 first ring gain-enhancing units 3321, wherein these first ring gain-enhancing units 3321 are arranged as a 5 by 5 matrix on the upper surface 3311 of the radome body 331. The second gain-enhancing pattern 333 includes 25 second ring gain-enhancing units 3331, wherein these second ring gain-enhancing units 3331 are arranged as a 5 by 5 matrix on the lower surface 3312 of the radome body 331. Moreover, as shown in FIG. 3A, the first gain-enhancing pattern 332 and the second gain-enhancing pattern 333 are formed on the upper surface 3311 and the lower surface 3312 of the radome body 331 correspondingly and respectively.

As shown in FIG. 3C and FIG. 3D, the first ring gain-enhancing units 3321 is a first split ring resonator 3322, while the second ring gain-enhancing units 3331 is a second split ring resonator 3332. Besides, the first split ring resonator 3322 includes a first conductive ring 3323 and a second conductive ring 3324, wherein the second conductive ring 3324 is enclosed by the first conductive ring 3323. The second split ring resonator 3332 includes a third conductive ring 3333 and a fourth conductive ring 3334, wherein the fourth conductive ring 3334 is enclosed by the third conductive ring 3333. Moreover, the neighboring first split ring resonator 3322 are separated by a distance s, while the neighboring second split ring resonator 3332 are separated by a distance s, too.

As shown in FIG. 3C and FIG. 3D, the first conductive ring 3323 and the second conductive ring 3324 have an opening 3325, 3326, respectively. The opening direction of the first conductive ring 3323 is opposite to the opening direction of the second conductive ring 3324. The third conductive ring 3333 and the fourth conductive ring 3334 have an opening 3335, 3336, respectively. The opening direction of the third conductive ring 3333 is opposite to the opening direction of the fourth conductive ring 3334. Moreover, the opening direction of the first conductive ring 3323 (i.e. the X-direction of FIG. 3C) is perpendicular to the opening direction of the third conductive ring 3333 (i.e. the Y-direction of FIG. 3D).

It should be noticed that, even though the first conductive ring 3323, the second conductive ring 3324, the third conductive ring 3333 and the fourth conductive ring 3334 are rectangular ring in the present embodiment, the first conductive ring 3323, the second conductive ring 3324, the third conductive ring 3333 and the fourth conductive ring 3334 can be any kind of rings, such as circular ring or elliptical ring, depending on the requirement in different applications.

The values of the labels in FIG. 3E for showing the size of the first split ring resonator 3322 are listed in the Table 2 below:

TABLE 2

| | | | | | |
|---|---|---|---|---|---|
| r | 3.1 | c | 0.4 | d | 0.4 |
| g | 0.2 | s | 0.4 | s | 0.4 |

Moreover, the size of the aforementioned second split ring resonator 3332 is the same as that of the first split ring resonator 3322. The only difference between them is the opening direction of the conductive rings they have, respectively.

Therefore, the total thickness of the microstrip patch antenna according to one another embodiment of the present invention, i.e. the sum of the thickness of the substrate 31 (H=1.5 mm), the thickness of the air layer (hg=13 mm), and the thickness of the radome 33 (h=0.8 mm), is 15.3 mm, which is much thinner than the total thickness of the conventional microstrip patch antenna having a multi-layered dielectric layer. Moreover, the thickness of the air layer of the microstrip patch antenna according to one another embodiment of the present invention is only about 0.1 times of the wavelength of the high frequency signal (the frequency thereof is about 2.5 GHz), which is much thinner than the thickness of the air layer of the conventional microstrip patch antenna having a multi-layered dielectric layer.

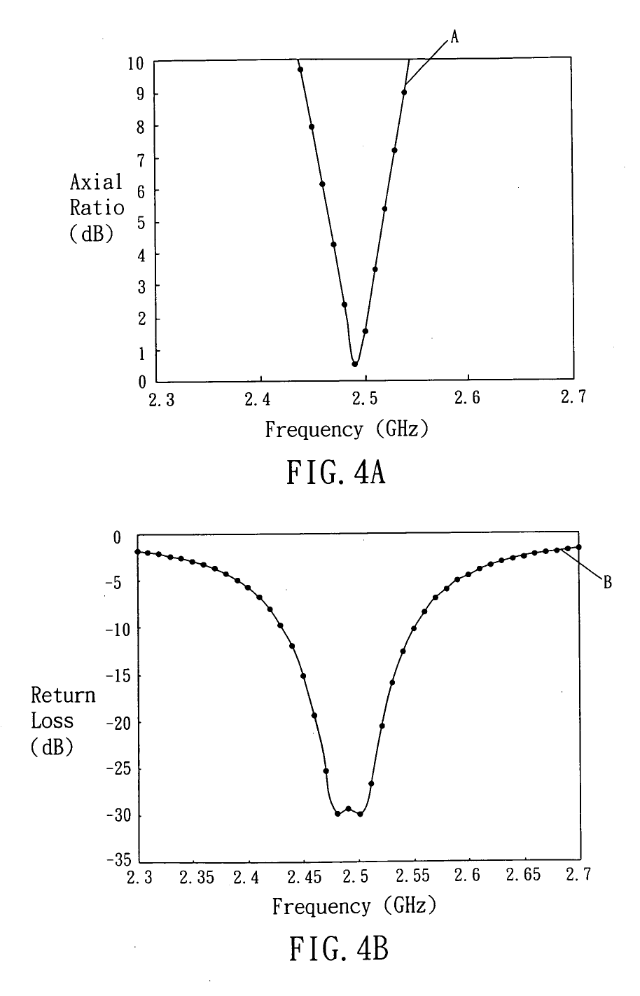

FIG. 4A and FIG. 4B are the schematic diagrams showing the variation between the axial ratio and the frequency and the variation between the return loss of a microstrip patch antenna capable of emitting or receiving a circularly polarized high frequency signal, obtained from the simulation performed by an electromagnetic simulation software. Besides, the size and the consisting material of the substrate and the antenna body of this microstrip patch antenna are the same as those of the substrate and the antenna body of the microstrip patch antenna according to one another embodiment of the present invention. In FIG. 4A, the curve A shows the variation between the axial ratio and the frequency of the circularly polarized high frequency signal obtained from the simulation. In FIG. 4B, the curve B shows the variation between the return loss and the frequency of the circularly polarized high frequency signal obtained from the simulation.

Besides, as shown in FIG. 4A and FIG. 4B, the resonant frequency of this microstrip patch antenna (without any radome) is about 2.495 GHz, while the 10-dB bandwidth of the return loss thereof is about 0.12 GHz. Moreover, the 3-dB bandwidth of the axial ratio of this microstrip patch antenna is about 0.2 GHz, while the flat gain between the 2.47 GHz and 2.52 GHz is about 2.8 dBic.

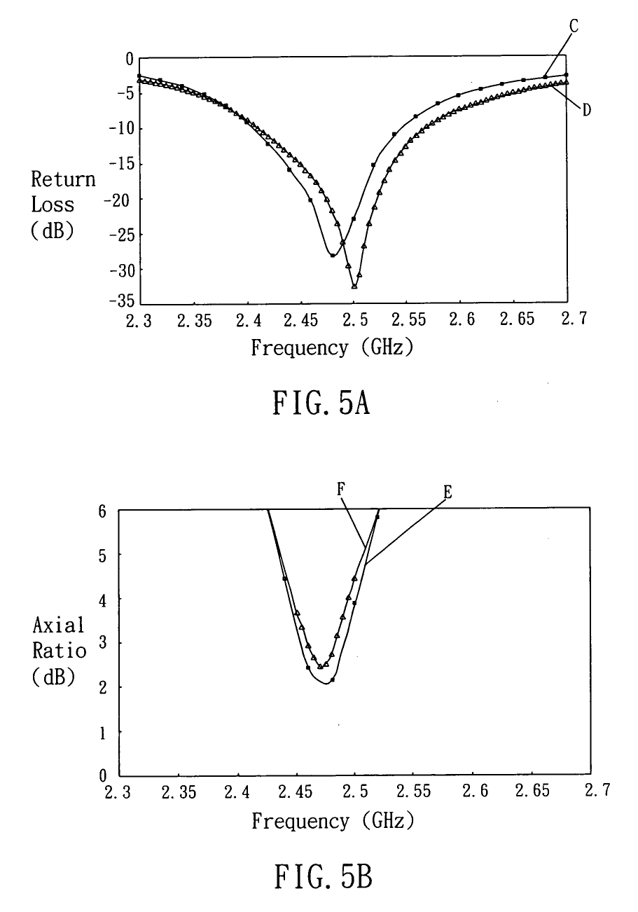

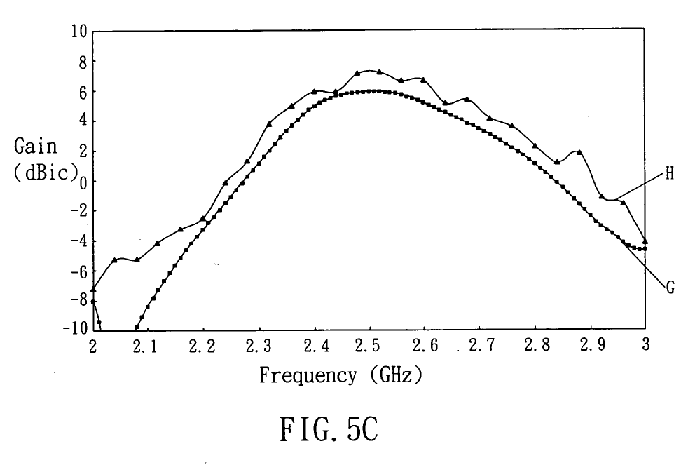

Moreover, FIG. 5A, FIG. 5B and FIG. 5C are the schematic diagrams showing the variation between the return loss and the frequency, the variation between the axial ratio and the frequency, and the variation between the gain and the frequency of a microstrip patch antenna according to one another embodiment of the present invention, obtained from the simulation performed by an electromagnetic simulation software and from the measurement on the microstrip patch antenna. In FIG. 5A, the curve C and the curve D show the variation between the return loss and the frequency of the circularly polarized high frequency signal obtained from the simulation and the measurement, respectively. In FIG. 5B, the curve E and the curve F show the variation between the axial ratio and the frequency of the circularly polarized high frequency signal obtained from the simulation and the measurement, respectively. In FIG. 5C, the curve G and the curve H show the variation between the gain and the frequency of the circularly polarized high frequency signal obtained from the simulation and the measurement, respectively.

As shown in FIG. 5A, FIG. 5B and FIG. 5C, the 10-dB bandwidth of the return loss of the microstrip patch antenna according to one another embodiment of the present invention (having a radome) is about 0.146 GHz, and the 3-dB bandwidth of the axial ratio thereof is about 0.025 GHz. The maximum gain of the microstrip patch antenna according to one another embodiment of the present invention is about 7.1 dBic (around 2.48 GHz). Moreover, the resonant frequency and the gain obtained from the measurement are both a little higher than those obtained from the simulation.

As a result, by having a radome, the microstrip patch antenna according to one another embodiment of the present invention can increase the gain value (from 2.8 dBic to 7.1 dBic), while maintaining the waveform of the circularly polarized high frequency signal.

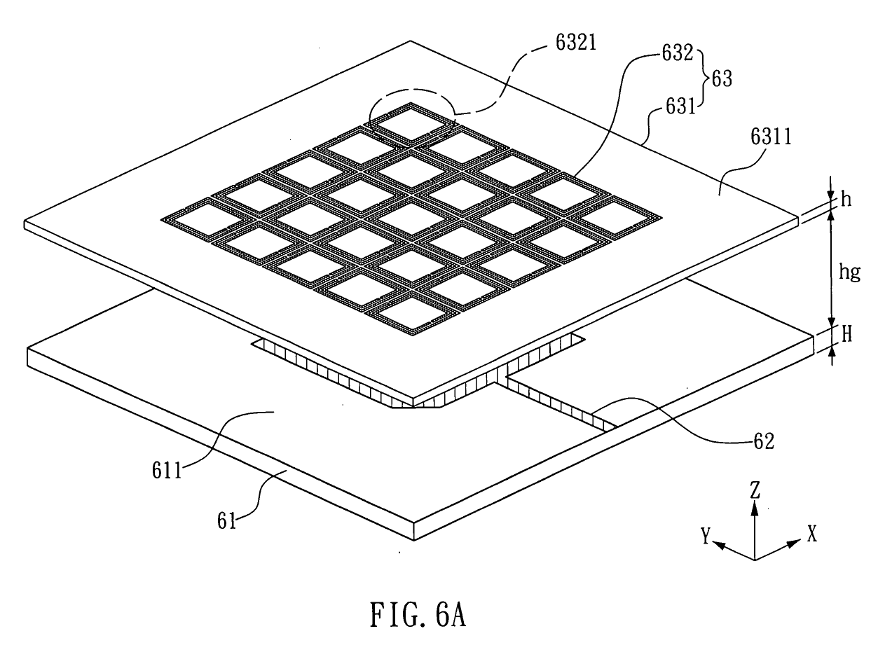

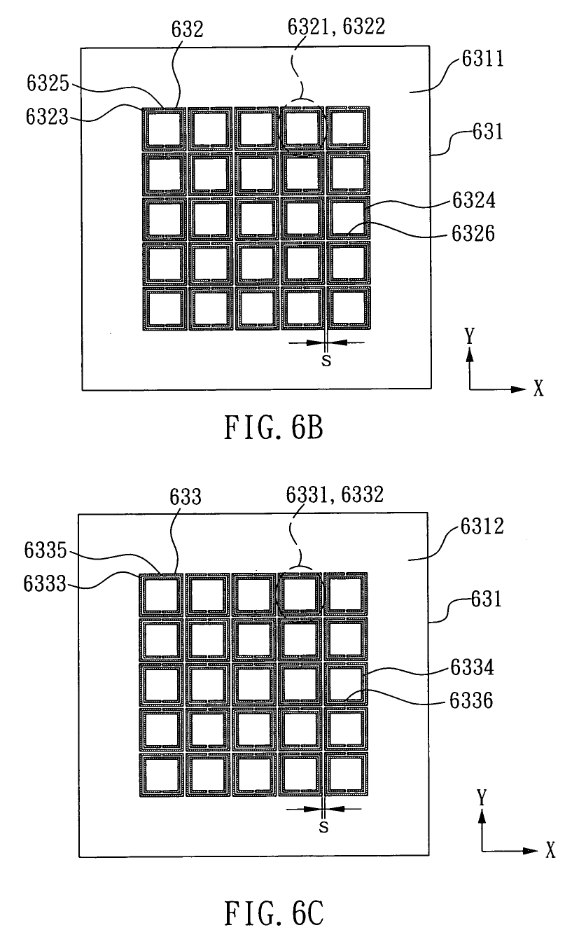

As shown in FIG. 6A, the microstrip patch antenna according to still another embodiment of the present invention comprises: a substrate 61, an antenna body 62 and a radome 63, wherein the antenna body 62 is located on the surface 611 of the substrate 61, and the radome 63 is located above the antenna body 62. The antenna body 62 is located between the substrate 61 and the radome 63. Besides, as the size and the form of the antenna body 62 of the microstrip patch antenna according to still another embodiment of the present invention are the same as those of the antenna body 32 of the microstrip patch antenna according to one another embodiment of the present invention, detailed description on the antenna body 62 will be omitted here.

On the other hand, the composition of the radome 63 of the microstrip patch antenna according to still another embodiment of the present invention is similar to that of the radome 33 of the microstrip patch antenna according to one another embodiment of the present invention, the only difference thereinbetween are the form (i.e. the opening direction) of the “first split ring resonator” and the “second split ring resonator”. Nevertheless, the size of the “first split ring resonator” and the “second split ring resonator” of these two radomes are the same, as listed in the aforementioned Table 2.

As shown in FIG. 6B, the first gain-enhancing pattern 632 located on the upper surface 6311 of the radome body 631 of the radome includes a plurality of first ring gain-enhancing units 6321, wherein each of the first ring gain-enhancing units 6321 is a first split ring resonator 6322. Besides, the neighboring first split ring resonator 6322 are separated by a distance s. The first split ring resonator 6322 includes a first conductive ring 6323 and a second conductive ring 6324, wherein the second conductive ring 6324 is enclosed by the first conductive ring 6323. The first conductive ring 6323 and the second conductive ring 6324 have an opening 6325, 6326, respectively. The opening direction of the first conductive ring 6323 is opposite to the opening direction of the second conductive ring 6324. The opening direction of the first conductive ring 6323 is parallel with the Y-direction of FIG. 6B.

As shown in FIG. 6C, the second gain-enhancing pattern 633 located on the lower surface 6312 of the radome body 631 of the radome includes a plurality of second ring gain-enhancing units 6331, wherein each of the second ring gain-enhancing units 6331 is a second split ring resonator 6332. Besides, the neighboring second split ring resonator 6332 are separated by a distance s. The second split ring resonator 6332 includes a third conductive ring 6333 and a fourth conductive ring 6334, wherein the fourth conductive ring 6334 is enclosed by the third conductive ring 6333. The third conductive ring 6333 and the fourth conductive ring 6334 have an opening 6335, 6336, respectively. The opening direction of the third conductive ring 6333 is opposite to the opening direction of the fourth conductive ring 6334. The opening direction of the third conductive ring 6333 is parallel to the Y-direction of FIG. 6C. That is, in the present embodiment, the opening direction of the first conductive ring 6323 (i.e. the Y-direction of FIG. 6B) of the first split ring resonator 6322 is parallel with the opening direction of the third conductive ring 6333 (i.e. the Y-direction of FIG. 6C) of the second split ring resonator 6332.

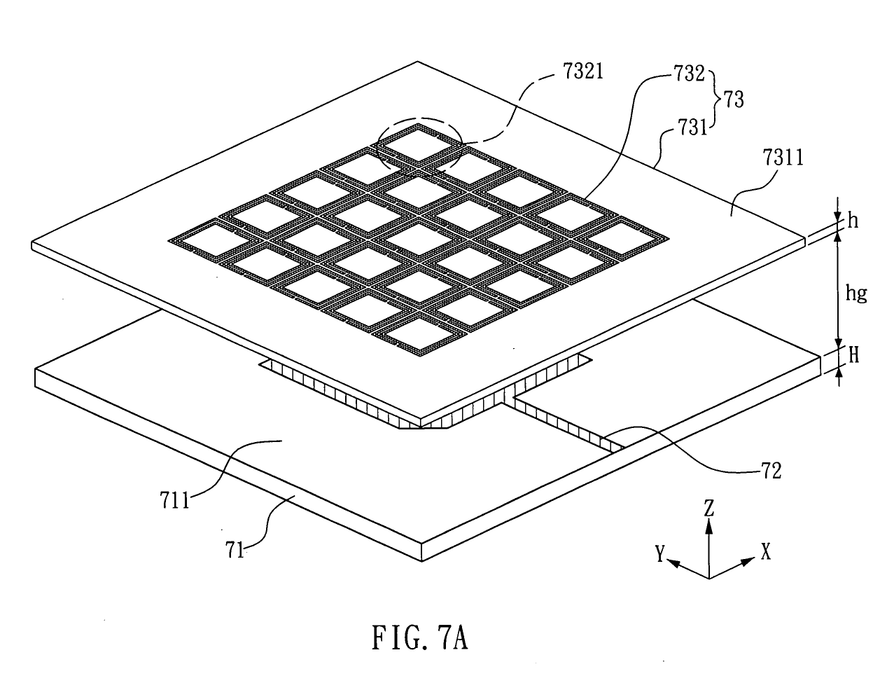

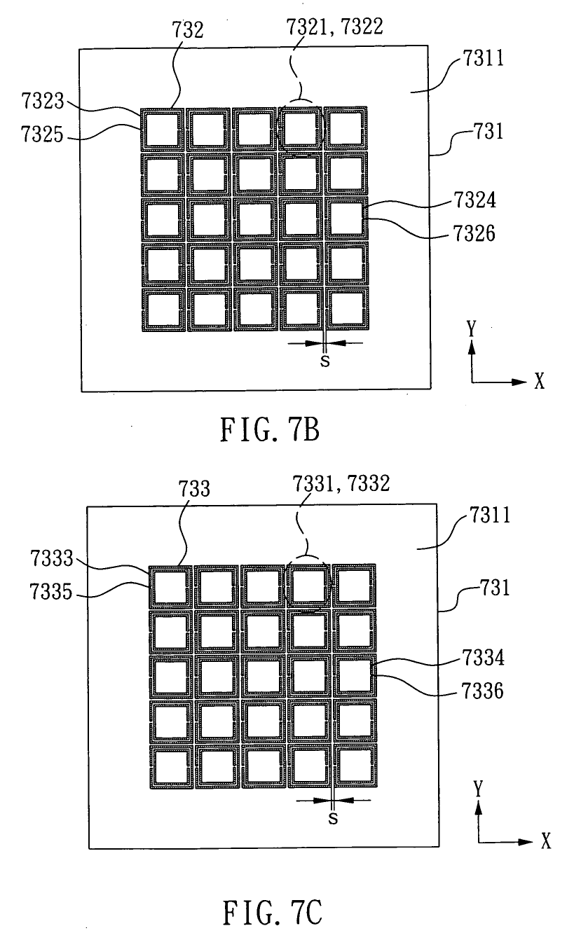

As shown in FIG. 7A, the microstrip patch antenna according to still another embodiment of the present invention comprises: a substrate 71, an antenna body 72 and a radome 73, wherein the antenna body 72 is located on the surface 711 of the substrate 71, and the radome 73 is located above the antenna body 72. The antenna body 72 is located between the substrate 71 and the radome 73. Besides, as the size and the form of the antenna body 72 of the microstrip patch antenna according to still another embodiment of the present invention are the same as those of the antenna body 32 of the microstrip patch antenna according to one another embodiment of the present invention, detailed description on the antenna body 72 will be omitted here.

On the other hand, the composition of the radome 73 of the microstrip patch antenna according to still another embodiment of the present invention is similar to that of the radome 33 of the microstrip patch antenna according to one another embodiment of the present invention, the only difference thereinbetween are the form (i.e. the opening direction) of the “first split ring resonator” and the “second split ring resonator”. Nevertheless, the size of the “first split ring resonator” and the “second split ring resonator” of these two radomes are the same, as listed in the aforementioned Table 2.

As shown in FIG. 7B, the first gain-enhancing pattern 732 located on the upper surface 7311 of the radome body 731 of the radome includes a plurality of first ring gain-enhancing units 7321, wherein each of the first ring gain-enhancing units 7321 is a first split ring resonator 7322. Besides, the neighboring first split ring resonators 7322 are separated by a distance s. The first split ring resonator 7322 includes a first conductive ring 7323 and a second conductive ring 7324, wherein the second conductive ring 7324 is enclosed by the first conductive ring 7323. The first conductive ring 7323 and the second conductive ring 7324 have an opening 7325, 7326, respectively. The opening direction of the first conductive ring 7323 is opposite to the opening direction of the second conductive ring 7324. The opening direction of the first conductive ring 7323 is parallel with the X-direction of FIG. 7B.

As shown in FIG. 7C, the second gain-enhancing pattern 733 located on the lower surface 7312 of the radome body 731 of the radome includes a plurality of second ring gain-enhancing units 7331, wherein each of the second ring gain-enhancing units 7331 is a second split ring resonator 7332. Besides, the neighboring second split ring resonators 7332 are separated by a distance s. The second split ring resonator 7332 includes a third conductive ring 7333 and a fourth conductive ring 7334, wherein the fourth conductive ring 7334 is enclosed by the third conductive ring 7333. The third conductive ring 7333 and the fourth conductive ring 7334 have an opening 7335, 7336, respectively. The opening direction of the third conductive ring 7333 is opposite to the opening direction of the fourth conductive ring 7334. The opening direction of the third conductive ring 7333 is parallel to the X-direction of FIG. 7C. That is, in the present embodiment, the opening direction of the first conductive ring 7323 (i.e. the X-direction of FIG. 7B) of the first split ring resonator 7322 is parallel with the opening direction of the third conductive ring 7333 (i.e. the X-direction of FIG. 7C) of the second split ring resonator 7332.

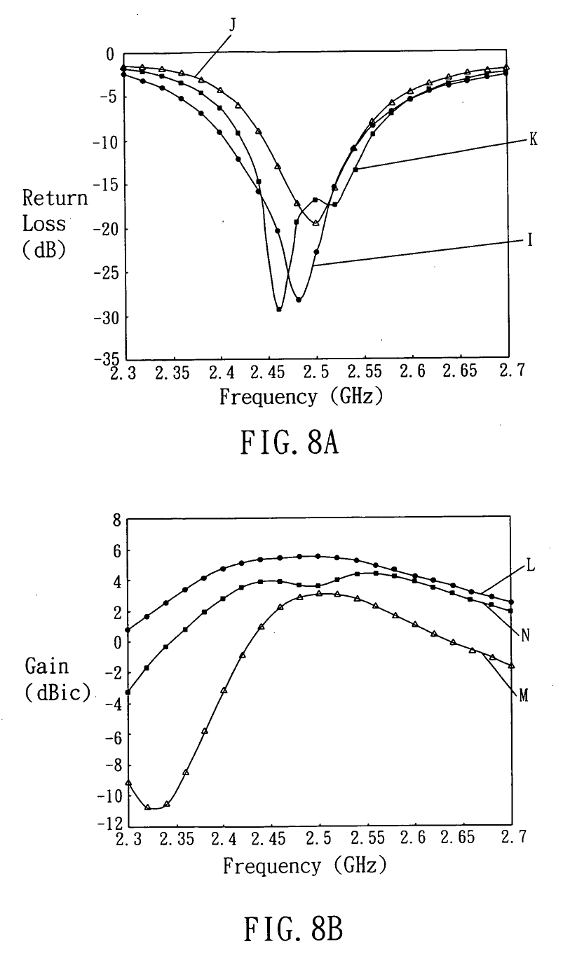

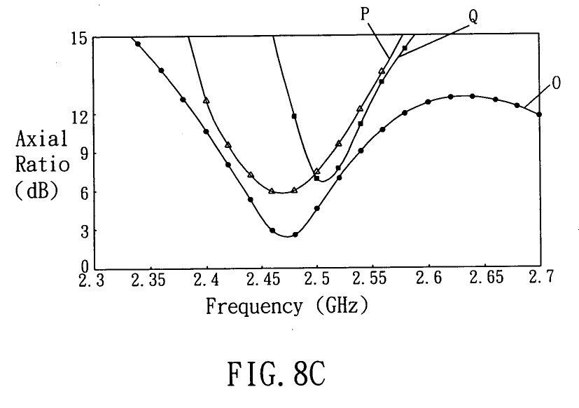

FIG. 8A, FIG. 8B and FIG. 8C are the schematic diagrams showing the variations between the return loss and the frequency, the variations between the gain and the frequency, and the variations between the axial ratio and the frequency of the microstrip patch antennas according to one another embodiment, still another embodiment, and still another embodiment of the present invention, respectively, obtained from the simulation performed by an electromagnetic simulation software.

In FIG. 8A, the curve I shows the variation between the return loss and the frequency of the microstrip patch antennas according to one another embodiment obtained from the simulation, the curve J shows the variation between the return loss and the frequency of the microstrip patch antennas according to still another embodiment obtained from the simulation, and the curve K shows the variation between the return loss and the frequency of the microstrip patch antennas according to still another embodiment obtained from the simulation.

In FIG. 8B, the curve L shows the variation between the gain and the frequency of the microstrip patch antennas according to one another embodiment obtained from the simulation, the curve M shows the variation between the gain and the frequency of the microstrip patch antennas according to still another embodiment obtained from the simulation, and the curve N shows the variation between the gain and the frequency of the microstrip patch antennas according to still another embodiment obtained from the simulation.

In FIG. 8C, the curve O shows the variation between the axial ratio and the frequency of the microstrip patch antennas according to one another embodiment obtained from the simulation, the curve P shows the variation between the axial ratio and the frequency of the microstrip patch antennas according to still another embodiment obtained from the simulation, and the curve Q shows the variation between the axial ratio and the frequency of the microstrip patch antennas according to still another embodiment obtained from the simulation.

As shown in FIG. 8A, the bandwidth of the return loss of the microstrip patch antenna according to one another embodiment is better than the bandwidths of the return loss of the microstrip patch antennas according to the other two embodiments (in the region from 2.46 GHz to 2.49 GHz). As shown in FIG. 8B, the gain value of the microstrip patch antenna according to one another embodiment is better than the gain values of the microstrip patch antennas according to the other two embodiments in the whole region (from 2.3 GHz to 2.7 GHz). Finally, as shown in FIG. 8C, the circular property of the microstrip patch antenna according to one another embodiment is better than the circular properties of the microstrip patch antennas according to the other two embodiments.

As described above, by having the radome body that comprises a first gain-enhancing pattern and a second gain-enhancing pattern on the upper surface and the lower surface thereof respectively, wherein the first gain-enhancing pattern includes a plurality of first ring gain-enhancing units and the second gain-enhancing pattern includes a plurality of second ring gain-enhancing units, the gain value of a microstrip patch antenna having the radome of the present invention can be increased significantly. Moreover, the thickness of the radome of the present invention almost equals to the thickness of the radome body thereof (i.e. 0.8 mm), which is significantly thinner than the conventional radome. As a result, the gain value of the microstrip patch antenna having the radome of the present invention (i.e. the microstrip patch antenna of the present invention) can be increased significantly, and the circular property of the microstrip patch antenna can also be maintained at a certain level, while the size of the antenna remains in a limited size.

Although the present invention has been explained in relation to its preferred embodiment, it is to be understood that many other possible modifications and variations can be made without departing from the scope of the invention as hereinafter claimed.

What is claimed is:

1. A radome comprising:
a radome body, having an upper surface and a lower surface;
a first gain-enhancing pattern, locating on the upper surface and including a plurality of first ring gain-enhancing units; and
a second gain-enhancing pattern, locating on the lower surface and including a plurality of second ring gain-enhancing units;
wherein each of the plurality of the first ring gain-enhancing units and each of the plurality of the second ring gain-enhancing units has an opening, respectively, and the opening direction of the plurality of the first ring gain-enhancing units is perpendicular to the opening direction of the plurality of the second ring gain-enhancing units.

2. The radome as claimed in claim 1, wherein the first ring gain-enhancing unit is a first single ring, and the second ring gain-enhancing unit is a second single ring.

3. The radome as claimed in claim 2, wherein the first single ring and the second single ring are a rectangular ring, respectively.

4. The radome as claimed in claim 1, wherein the first ring gain-enhancing unit is a first split ring resonator, and the second ring gain-enhancing unit is a second split ring resonator.

5. The radome as claimed in claim 4, wherein the first split ring resonator includes a first conductive ring and a second conductive ring, and the second conductive ring is enclosed by the first conductive ring.

6. The radome as claimed in claim 5, wherein the second split ring resonator includes a third conductive ring and a fourth conductive ring, and the fourth conductive ring is enclosed by the third conductive ring.

7. The radome as claimed in claim 6, wherein the first conductive ring, the second conductive ring, the third conductive ring, and the fourth conductive ring are rectangular conductive rings.

8. The radome as claimed in claim 6, wherein the first conductive ring and the second conductive ring have an opening, respectively, and the opening direction of the first conductive ring is opposite to the opening direction of the second conductive ring.

9. The radome as claimed in claim 8, wherein the third conductive ring and the fourth conductive ring have an opening, respectively, and the opening direction of the third conductive ring is opposite to the opening direction of the fourth conductive ring.

10. The radome as claimed in claim 9, wherein the opening direction of the third conductive ring is perpendicular to the opening direction of the first conductive ring.

11. a microstrip patch antenna comprising:
a substrate;
an antenna body, locating on the surface of the substrate; and
a radome, locating above the antenna body, and the antenna body being located between the substrate and the radome;
wherein the radome includes a radome body having an upper surface and a lower surface, a first gain-enhancing pattern and a second gain-enhancing pattern; the first gain-enhancing pattern locates on the upper surface and includes a plurality of first ring gain-enhancing units; the second gain-enhancing pattern locates on the lower surface and includes a plurality of second ring gain-enhancing units;
wherein each of the plurality of the first ring gain-enhancing units and each of the plurality of the second ring gain-enhancing units has an opening, respectively, and the opening direction of the plurality of the first ring gain-enhancing units is perpendicular to the opening direction of the plurality of the second ring gain-enhancing units.

12. The microstrip patch antenna as claimed in claim 11, wherein the microstrip patch antenna emits a high frequency signal having a circular polarization.

13. The microstrip patch antenna as claimed in claim 11, wherein the first ring gain-enhancing unit is a first split ring resonator, and the second ring gain-enhancing unit is a second split ring resonator.

14. The microstrip patch antenna as claimed in claim 13, wherein the first split ring resonator includes a first conductive ring and a second conductive ring, and the second conductive ring is enclosed by the first conductive ring.

15. The microstrip patch antenna as claimed in claim 14, wherein the second split ring resonator includes a third conductive ring and a fourth conductive ring, and the fourth conductive ring is enclosed by the third conductive ring.

16. The microstrip patch antenna as claimed in claim 15, wherein the first conductive ring, the second conductive ring, the third conductive ring, and the fourth conductive ring are rectangular conductive rings.

17. The microstrip patch antenna as claimed in claim 15, wherein the first conductive ring and the second conductive ring have an opening, respectively, and the opening direction of the first conductive ring is opposite to the opening direction of the second conductive ring.

18. The microstrip patch antenna as claimed in claim 17, wherein the third conductive ring and the fourth conductive ring have an opening, respectively, and the opening direction of the third conductive ring is opposite to the opening direction of the fourth conductive ring.
